(19) United States
(12) Patent Application Publication
(10) Pub. No.: US 2025/0302222 A1
(43) Pub. Date: Oct. 2, 2025

(54) ABSORBENT FLOOR MAT

(71) Applicant: Protection Products, Inc., Hickory, NC (US)

(72) Inventor: Jeffrey Wayne Hale, Hickory, NC (US)

(73) Assignee: Protection Products, Inc., Hickory, NC (US)

(21) Appl. No.: 19/094,287

(22) Filed: Mar. 28, 2025

Related U.S. Application Data
(60) Provisional application No. 63/571,430, filed on Mar. 28, 2024.

(51) Int. Cl. A47G 27/02; B32B 3/04; B32B 5/02; B32B 7/12; B32B 27/12; B32B 27/32

(52) U.S. Cl. CPC A47G 27/0206; B32B 3/04; B32B 5/022; B32B 27/12; B32B 27/32; B32B 7/12; B32B 2262/0253; B32B 2307/726; B32B 2307/7265; B32B 2307/744; B32B 2471/04

(57) ABSTRACT

Absorptive floor mats for a medical environment are shown and described. In one embodiment, the floor mat may be a cart washer runner. The cart washer runner may be absorbent and maintain position securely to a floor in a high traffic area. A floor mat may include layers. The layers may be different layers. The layers include an absorptive layer and an impermeable layer. The floor mat may include an edge. The floor mat may retain moisture on a mat body and include reinforced sides and ends.

This application claims priority to U.S. Provisional Application No. 63/571,430 filed Mar. 28, 2024, which is incorporated herein by reference in its entirety.

### FIELD OF THE TECHNOLOGY

The present disclosure relates generally to absorbent floor mats, and more particularly to improved cart washer runners, edged absorbent mats, and medical mats having an edge treatment. Further, the disclosure includes methods for safety and protection in medical scenarios where infection/disinfection and prevention of overspill and contamination may be of concern. Further, the present disclosure relates to disposable floor coverings/mats in medical situations, for example in emergency rooms, hospitals, surgical wards, research facilities dealing with sterilization and prevention of cross-contamination, and downtime relating to sterilization procedures.

### BACKGROUND

Advances in medical science have brought technological improvement and more sophisticated equipment into the medical setting. By way of example, cart wash disinfectors have been developed that have low power consumption, short-cycle times, and chamber customization for sterilizing trolleys, equipment, and/or carts that need to remain or become sterilized.

Carts may, for example, be used to carry sterile containers, wash bowls, large bin type items, rubber shoes, medical equipment, etc. that by themselves are time consuming and difficult to sterilize. Automating the process so the cart can be loaded with items and then the cart rolled in its entirety into a cart washer, saves time and money. Equipment is retuned to service quicker, efficiency and confidence of sterilization is higher, and persons are relieved of repetitive, dangerous, and meticulous decontamination work.

However, such advances often come with challenges and here, Applicant realized the carts exert wear on the floor surfaces and may create a different dangerous situation, by way of example, a non-sterilized cart may spill hazardous fluids from containers and sterilized carts may not be dry when removed from the cart wash disinfector.

Also in medical scenarios, for example in emergency rooms, hospitals, surgical wards, and/or research facilities that deal with sterilization, treatment, and prevention of cross-contamination, containment of hazards, spills, and/or fluid wastes may take up personnel time, involve issues of liability, impact costs and effectiveness, and be a major financial and efficiency consideration. The issues of contamination and sterilization are constant challenges.

Therefore, Applicants desire systems, devices, and methods for absorbent floor coverings to overcome concerns and improve the safety of scenarios surrounding medical wastes, and fluid spillage and containment, for example as with carts and cart wash disinfectors.

### SUMMARY

In accordance with the present disclosure, one embodiment includes an absorbent floor mat. One example of an absorbent floor mat may be considered a cart washer runner. An absorbent floor mat may include, in certain examples, a body, a front surface, a bottom surface, a first end, a second end, a first side, a second side and an edge. The edge may for a perimeter around the body. The absorbent floor may include layers. The layers may be formed of different materials. Layers may include, for example, an absorbent layer, an adhesive layer, and/or an impervious layer.

In accordance with the present disclosure, cart washer runners are provided for use with cart washer disinfectors and carts. This disclosure provides improved floor mat systems and covers that are convenient, efficient, and safe for the user, economical for the facility, and an improvement in the field.

Other embodiments of the present disclosure include a cart washer runner. Cart washer runners may include a front and a bottom, a first end, a second end, a first side and a second side. Cart washer runners may include a body and an edge.

Coverings over medical room floors, for example, in front of a cart washer machine/device, receive a lot of traffic and repetitive type of wear. The wear is not just from potential hazardous substances, but also from foot traffic, and distinctly from carts that continually roll across the cart washer runner. The cart may be wet from sterilization and/or heavy from items the cart is carrying. Traditional types of floor mats may become slippery, contaminated, and/or wear from the unusual type of traffic. Typical absorbent drapes that may absorb fluids on a floor, may be prone to tearing and not withstand such wear. Mats or rugs can be expensive and not suitable to be disposable, especially if contaminated. A mat may be disposable after a single use, several uses, a days' use and/or after a number of uses, for example, in the case of a cart washer runner, after any number of carts have been sterilized in the cart washer device and have rolled across a cart washer mat.

In certain examples, a cart washer runner may include an edge that is reinforced. The edge may be considered an edge treatment. The reinforced edge may be made of a different material than the body of the cart washer runner. Corners of a cart washer runner may include reinforced edges that include an overlap.

Embodiments of an absorbent floor mat may include a body having multiple layers, and including an absorbent material. An absorptive layer may include multiple sheets of absorbent material. The absorbent floor mat may include an edge that may create an ingress/egress surface covering the layers to accommodate traffic or equipment onto and off the absorbent floor mat.

The absorbent floor mat may include an absorbent front surface. The absorbent floor mat may include an impervious bottom surface. The bottom surface may be a polyethylene backing. The bottom surface may be skid resistant. The bottom surface may include adhesive and/or an adhesive layer. The adhesive may be arranged in strips of adhesive. In some examples, the front surface and the bottom surface may be absorbent.

In other examples, the present disclosure includes a method for packaging absorbent floor mat, by way of example, a cart washer runner. A cart washer runner may be placed front surface down. A separator may be placed and fitted along the length of the cart washer runner, covering a portion of the width of the cart washer runner. In some examples, the separator may cover half of the width of the bottom surface. The bottom may be folded upon itself with the separator forming a layer between the two mating sides of the bottom surface. The folded cart washer runner may then be rolled from one end to the other forming a resulting car washer runner roll.

Some examples include an absorbent floor mat having at least one absorbent face, at least one impervious face, and a reinforced edge around the perimeter of the runner. The edge may surround the body. The reinforced edge may be formed of a material different than the front surface and/or the bottom surface. The reinforced edge may include overlap corners.

The absorbent floor mat may include a bottom surface that is skid resistant, a front surface that is absorbent, and an edge treatment that reinforces and strengthens the ends and sides of the floor mat. The absorbent floor mat may be structured to retain excess fluid on the body. The body may be an excess fluid retention body. The edge may be an edge treatment. The edge may be a fluid control edge. The edge may seal the outer perimeter of the absorbent floor mat and direct excess fluid away from the perimeter of the floor mat, to be retained on the body. The edge may be a fluid control edge. The edge may be an impervious edge. The edge may be a fluid resistant edge. The floor mat, in certain examples, may be lent free and/or latex free. The imperious layer may be waterproof.

Within the scope of the disclosure is a method for a floor covering according to any of the embodiments or combination of elements of the present disclosure. In another embodiment is a method for collecting and/or retaining medical wastes according to any of the embodiments or combination of elements of the present disclosure.

One example includes a roll of absorbent floor mat material, a roll of absorbent floor mat material including perforations, and/or an absorbent floor mat including an edge on at least one side and/or end of the body according to any of the embodiments or combination of elements of the present disclosure.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are the property of the Applicant. The Applicant retains and reserves all rights in its trademarks and copyrights included herein, and grants permission to reproduce the material only in connection with reproduction of the granted patent and for no other purpose.

The drawings, photographs, pictures, and the like may contain text or captions that may explain certain embodiments of the present disclosure. This text is included for illustrative, non-limiting, explanatory purposes of certain examples and elements detailed in the present disclosure.

Embodiments of the disclosure will be better understood by a reading of the Description of Embodiments along with a review of the drawings, in which:

FIG. 1 is an illustration showing examples of an absorbent floor mat, for example a cart washer runner, a cart, and a cart washer device, according to an embodiment of the disclosure;

FIG. 2 is a front view of an absorbent floor mat according to an embodiment of the present disclosure;

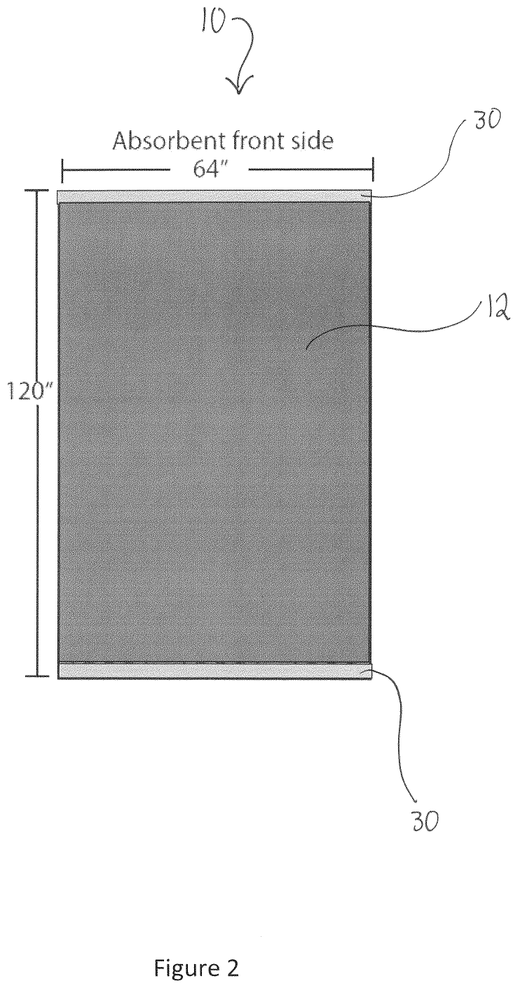

FIG. 3 is a bottom view of an absorbent floor mat according an embodiment of the present disclosure;

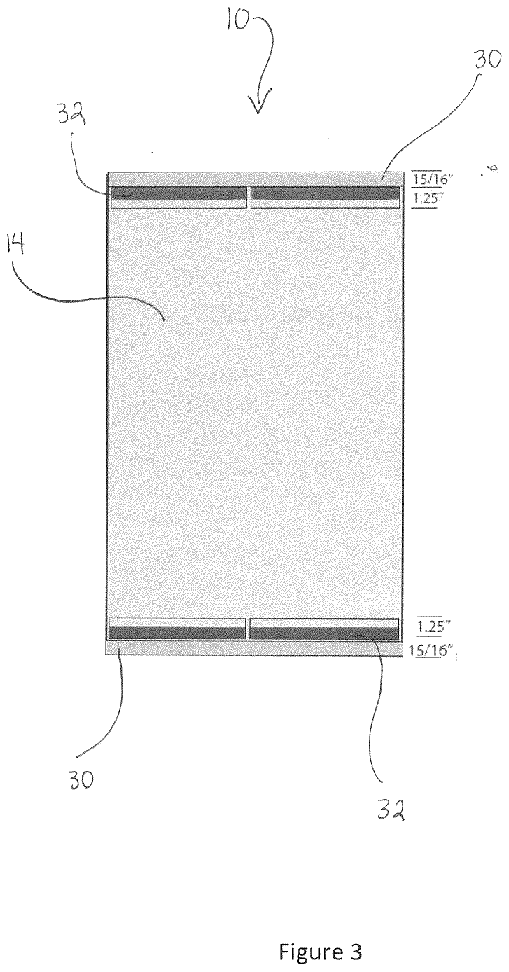

FIGS. 4A-4C illustrate one example of a method for packaging an embodiment of an absorbent floor mat, for example a cart washer runner as shown, according to embodiments of the disclosure;

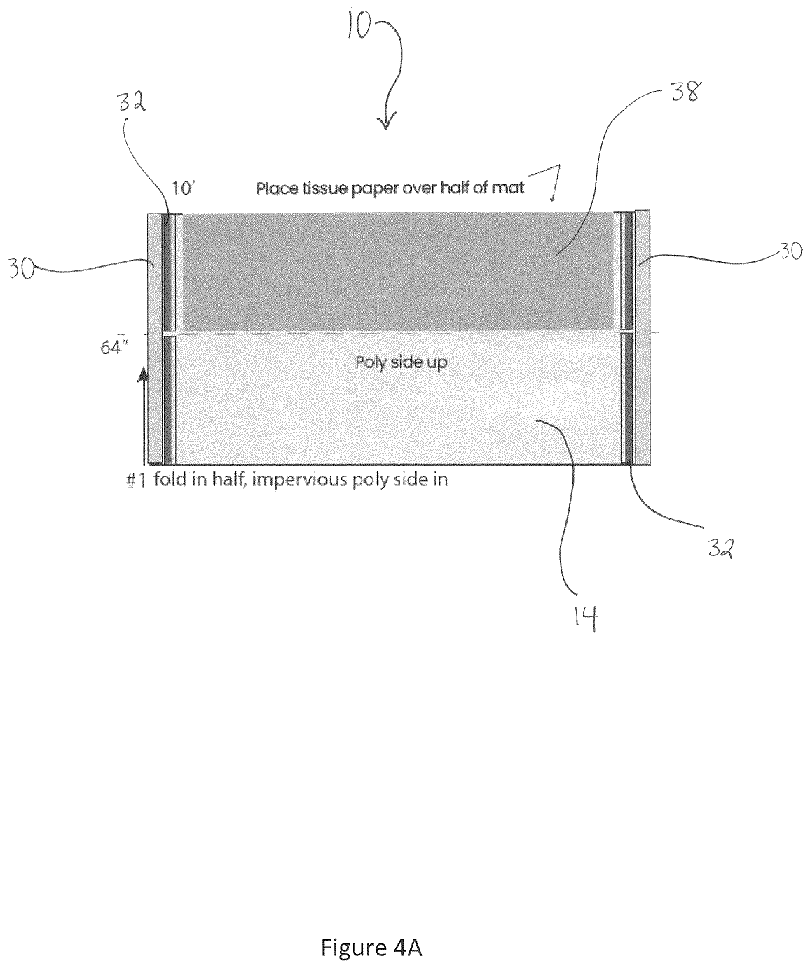

FIG. 5 is a front view of one example of an absorbent floor mat, for example a cart washer runner, including a reinforced edge according to the present disclosure;

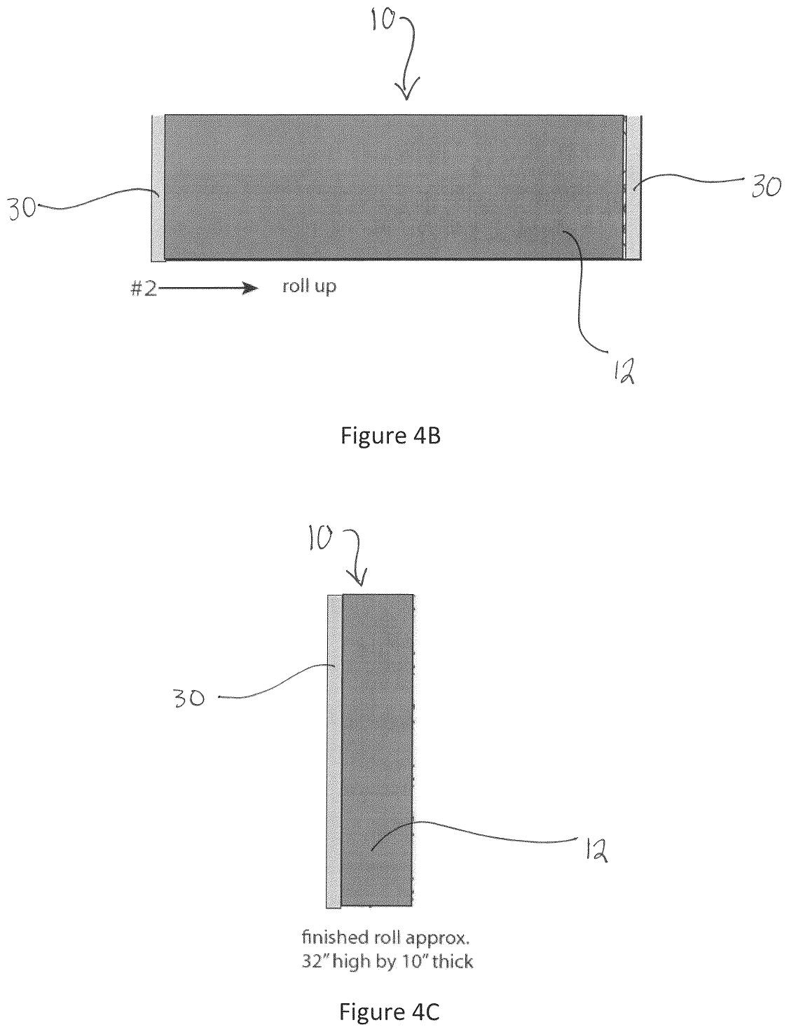

FIG. 6A is an example of an end of an absorbent floor mat showing layers and sheets, according to embodiments of the disclosure;

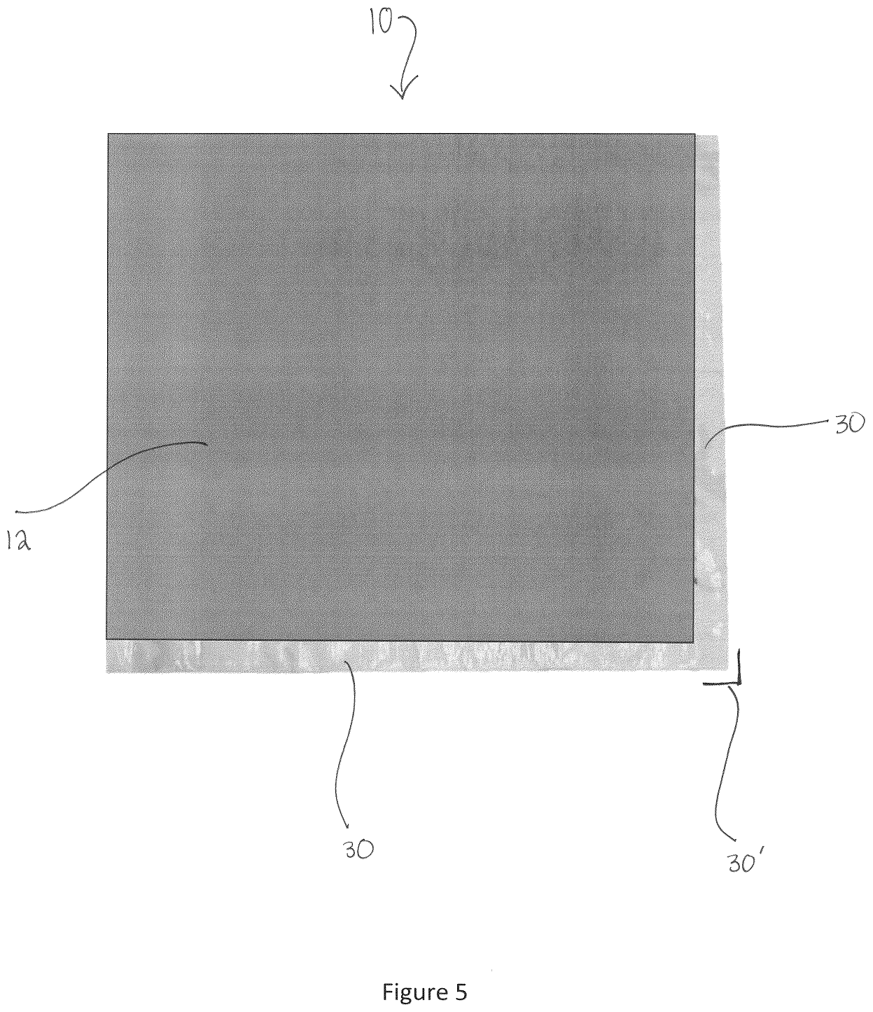

FIG. 6B is one example of a close up view of the end of an absorbent floor mat showing layers and sheets according to FIG. 6A; and

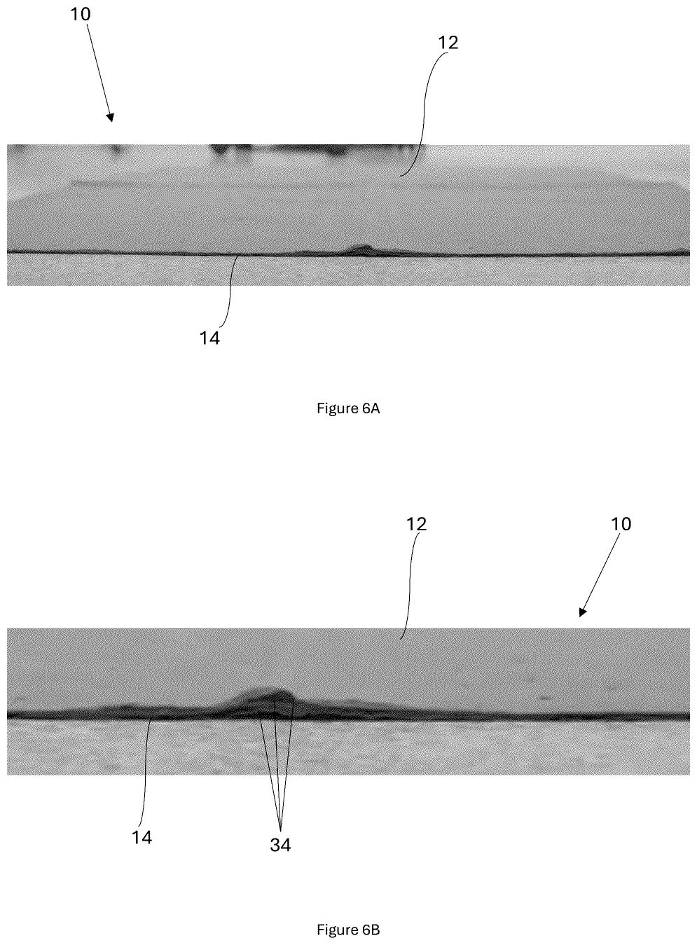

FIG. 7 shows examples of an edge surrounding a body of an absorbent floor mat, according to embodiments of the disclosure.

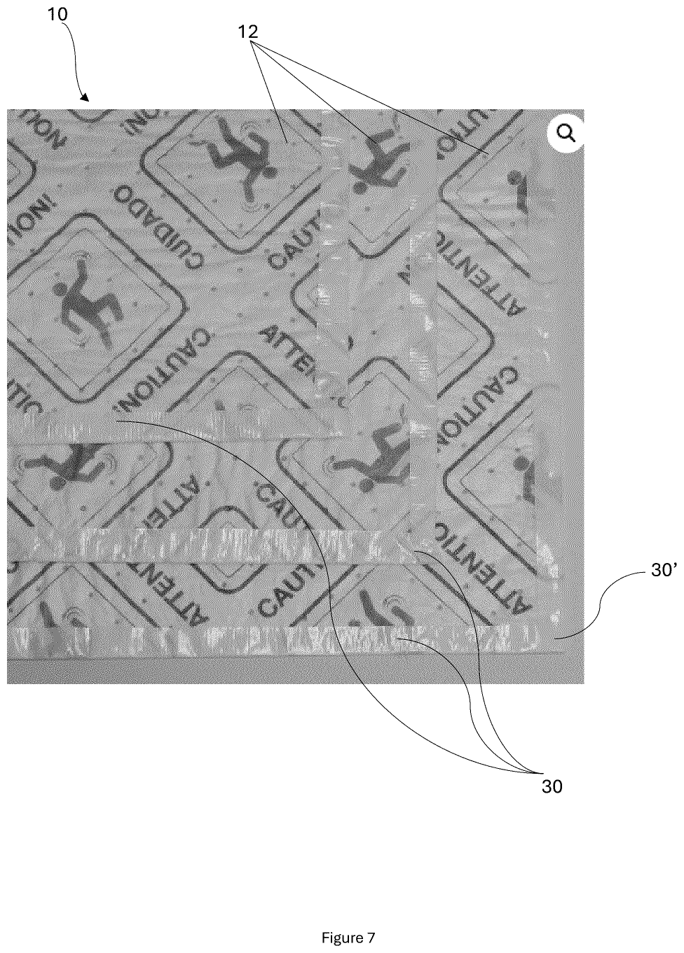

### DESCRIPTION OF EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

It will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified may be considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Certain examples and elements are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

The terms “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings, photographs, pictures, and the like. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure

The following may depict an example of a method, of a plurality of methods, that may be performed by at least one of the aforementioned embodiments, or components thereof. Further, although the elements here may be disclosed in a particular order, it should be understood that the order is disclosed for illustrative purposes only. Elements may be combined, separated, reordered, and various intermediary stages may exist. Accordingly, it should be understood that the various assemblies, in various embodiments, may be performed/assembled in orders that differ from the ones disclosed below. Moreover, various stages may be added or removed without altering or departing from the fundamental scope of the depicted methods and systems disclosed herein.

The foregoing overview, summary, and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the summary and detailed description.

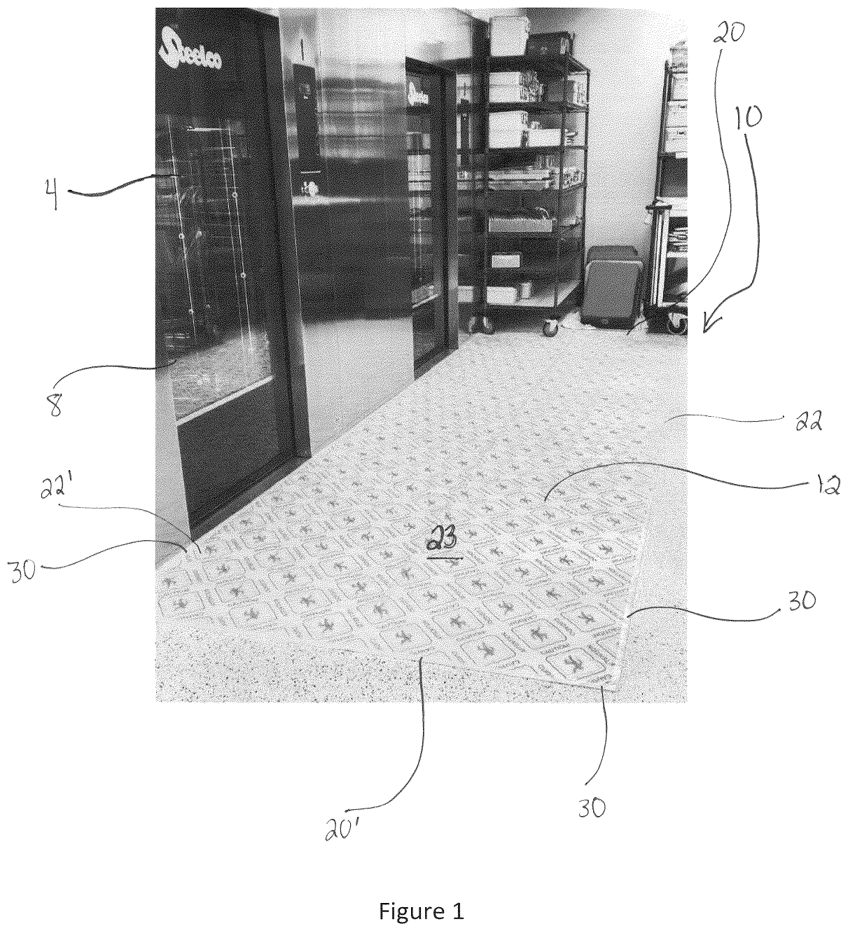

Referring now to the drawings in general and FIG. 1 in particular, it will be understood that the illustrations are for the purpose of describing embodiments of the disclosure and are not intended to limit the disclosure or any invention thereto. As best seen in the Figures generally, absorbent floor mat 10 is shown embodied according to the present disclosure. One example of an absorbent floor mat may be a cart washer runner. Absorbent floor mat 10 may include a front surface 12 and a bottom surface 14, a first end 20, a second end 20′, a first side 22 and a second side 22′. Absorbent floor mat 10 may include an edge 30. An edge 30 may surround selected sides and/or may form a perimeter around a body 23 of the cart washer runner. Edge 30 may be a reinforced edge. Edge 30 may be considered an edge treatment.

Corners 30′of a cart washer runner 10 may include reinforced edges 30 that include an overlap at the corner 30′.

Embodiments of an absorbent floor mat 10 may include a body 23 having multiple layers and/or multiple sheets of absorbent material. The multiple layers of absorbent sheets may form a superabsorbent body 23. Edge 30 may create a reinforced edge forming an ingress/egress surface to accommodate traffic or equipment onto and off the runner. The reinforced edge may prevent the absorbent floor mat from scrunching and moving during weight bearing, for example, in a cart washer runner where a cart rolls across the mat and/or where medical personnel in an emergency room walk across the mat surface.

The absorbent floor mat 10 may include an absorbent front surface 12. The absorbent floor mat 10 may include an impervious bottom surface 14. The bottom surface 14 may be a polyethylene backing. The bottom surface may be skid resistant. The bottom surface may be waterproof. The bottom surface 14 may include adhesive 32. The adhesive may form a layer. The adhesive may be arranged in strips of adhesive. In some examples, the front surface and the bottom surface may be absorbent.

Some examples include an absorbent floor mat 10 having at least one absorbent face, at least one impervious face, and a reinforced edge 30 around the perimeter of the runner. The reinforced edge 30 may be formed of a material different than the front surface 12 and/or the bottom surface 14. The reinforced edge 30 may include overlap corners 30′. The absorbent floor mat 10 may include at least two different layers. The absorbent floor mat 10 may include at least two layers composed of different material. The differential layers may be enclosed at the ends and/or sides by an edge.

Certain embodiments include a cart washer runner 10 of a polypropylene with polyethylene backing. A durable spun bond lint-free cover stock may be included. A meltblown polypropylene absorbent may be included. A skid resistant poly backing may be included.

An edge 30 may extend from covering a portion of the front surface 12, around the side surfaces 22, 22′/end surfaces 20, 20′, and to a portion of the bottom surface. An edge may cover a portion of the front surface. Examples of a reinforced edge 30 may include a tape, for example a duct tape, a sheeting, an impervious tape, etc. The tape may be a waterproof tape. The tape may be a skid resistant tape. The tape may be an adhesive tape.

An adhesive 32, by way of example, may be a double sided tape. The double sided tape may include a portion of easy peel. In some examples, the back surface 14 may include an edging of adhesive 32. A reinforced edge 30 may cover at least a portion of and be mated with the adhesive in certain embodiments. In other examples, a bottom face 14 may include an outer edging of tape, adjacent to an inner edging of adhesive. The front face 12 may include an edging of tape. The tape may wrap around from front surface 12 to back surface 14 and cover an outer edge of the body along each end 20, 20′ and, in some instances around each side 22, 22′. The edge 30 provides, in this example, a reinforced edge for durability but also providing a seamless, absorbent rolling surface that, for example, carts roll across with ease.

Examples include a cart washer runner of any size, shape or dimensions and by way of example, lengths may vary, as in a 15 foot, 10 foot, and 5 foot size example. Cart washer runners 10 may be single use. Cart washer runners 10 may be disposable. Cart washer runners 10 may be for multiple use. Cart washer runners may be skid resistant and absorbent (14×dry weight for example).

An absorbent layer of an absorbent floor mat 10 may include more than one sheet of absorbent material and may be dimple bonded.

Some examples include an absorbent floor mat having at least one absorbent face, at least one impervious face, and a reinforced edge around the perimeter of the runner. The edge may surround the body. The reinforced edge may be formed of a material different than the front surface and/or the bottom surface. The reinforced edge may include overlap corners. The absorbent floor mat may include a bottom surface that is skid resistant, a front surface that is absorbent, and an edge treatment that reinforces and strengthens the ends and sides of the floor mat. The absorbent floor mat may be structured to retain excess fluid on the body. The body may be an excess fluid retention body. The edge may be an edge treatment. The edge may be a fluid control edge. The edge may seal the outer perimeter of the absorbent floor mat and direct excess fluid away from the perimeter of the floor mat, to be retained on the body. The edge may be a fluid control edge. The edge may be an impervious edge. The edge may be a fluid resistant edge. The floor mat, in certain examples, may be lent free and/or latex free. The imperious layer may be waterproof.

Embodiments of an absorbent floor mat may include a fabric backed pressure sensitive material coated with polyethylene. An absorbent layer in some examples may be a durable meltblown polypropylene absorbent. An impervious layer may be a polyethylene backing, by way of example, may form a skid resistant 1.5 mil poly backing. The absorbent layer may include standard wt. absorbency of at least 14×dry weight. The absorbent layer may be dimple bonded.

In other examples, the present disclosure includes a method for packaging a cart washer runner. Cart washer runners may be large and bulky, covering a large amount of floor space. As a result, cart washer runners can be difficult to maneuver when extended. A method for a cart washer runner may include manipulating between an extended position and a travel position. The travel position allows for a fold and a roll that greatly reduces the sizing of the cart washer runner, in a manner that does not disrupt the absorbency or damage the runner. A cart washer runner may be placed front surface down. A separator 38 may be placed and fitted along the length of the cart washer runner, covering a portion of the width of the cart washer runner. In some examples, the separator may cover half of the width of the bottom surface. The bottom may be folded upon itself with the separator forming a layer between the two mating sides of the bottom surface. The folded cart washer runner may then be rolled from one end to the other forming a resulting roll. The resulting roll may be nearly half the width of the cart washer runner in the extended position.

Those of ordinary skill in the art having the benefit of this disclosure will recognize that a variety of other examples include a variety of differing shapes, styles, and sizes for the convenience of its user.

An absorbent floor mat, for example, a cart washer runner 10 kit may include more than one cart washer runner. The more than one cart washer runner kit may include more than one disposable runners rolled into a travel position. The more than one runners may be aligned and packaged adjacently for shipment or storage to save space, which is beneficial in hospitals and/or emergency rooms.

Numerous characteristics and advantages have been set forth in the foregoing description, together with details of structure and function. Many of the novel features are pointed out in the appended claims. The disclosure, however, is illustrative only, and changes may be made in detail, especially in matters of shape, size, and arrangement of parts, within the principle of the disclosure, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Elements and terms used herein refer to that which one of ordinary skill would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by one of ordinary skill should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

The specification includes examples, and while the specification has been described in language specific to structural features and/or methodological acts, the claims are not limited to the features or acts described above. Rather, the specific features and acts described above are disclosed as examples for embodiments of the disclosure. Insofar as the summary and description above and the accompanying drawing disclose any additional subject matter that is not within the scope of the claims below, the disclosures are not dedicated to the public and the right to file one or more applications to claims such additional disclosures is reserved.

What is claimed is:

1. A disposable, absorptive floor mat for use in medical scenarios comprising:
a body including layers formed of differential materials,
an absorbent front surface,
an impervious bottom surface,
an edge surrounding a perimeter of the body, wherein the edge is a reinforced edge.

2. The floor mat of claim 1 wherein the body includes multiple sheets of absorbent material.

3. The floor mat of claim 2 including an adhesive on a bottom surface of the body.

4. The floor mat of claim 2 wherein the edge is an impervious edge.

5. The floor mat of claim 4 wherein the edge includes overlapping corners.

6. The floor mat of claim 5 including multiple layers of absorbent material, and wherein the multiple layers of absorbent material including the edge form an easier egress and ingress for carts rolling across the floor mat.

7. The floor mat of claim 4 including more than one layer of absorbent material that is dimple bonded.

8. The floor mat of claim 4 wherein the edge is formed of a different material than the front surface and the bottom surface, and wherein the front surface is formed of a different material than the bottom surface.

9. The floor mat of claim 8 wherein the edge is a fluid control edge.

10. The floor mat of claim 9 wherein the body is a fluid retention body.

11. The floor mat of claim 10 wherein the edge seals the out perimeter of the floor mat and directs excess fluid away form the perimeter to be retained by the body.

12. The floor mat of claim 11 wherein the bottom surface is waterproof.

13. The floor mat of claim 11 wherein the absorbent layer includes a standard wt. absorbency of at least 14×dry weight.

14. The floor mat of claim 13 wherein the floor mat is a cart washer runner.

15. A method for controlling fluid waste in a medical environment comprising:
forming a disposable, absorptive floor mat,
topping a body of the floor mat with an absorptive surface,
covering a bottom surface of the body of the floor mat with an impervious surface,
surrounding a perimeter of a body of the floor mat with an edge.

16. The method of claim 15 including providing a water directing edge that urges fluid back toward the body and discourages water escaping from the floor mat.

17. The method of claim 16 including providing a fluid retention body.

18. The method of claim 17 including adding a skid resistant surface.

19. The method of claim 18 including adding a warning graphic to a top surface.

20. The method of claim 19 including providing an absorbent layer including at least 14×absorbency.
